(19) United States
(12) Patent Application Publication
(10) Pub. No.: US 2017/0313874 A1
(43) Pub. Date: Nov. 2, 2017

(54) POLYBUTYLENE TEREPHTHALATE COMPOSITIONS

(71) Applicant: LANXESS DEUTSCHLAND GMBH, COLOGNE (DE)

(72) Inventors: SARAH SANGERMANN, KOLN (DE); RALF ZIMNOL, OVERATH (DE); BORIS NEUWALD, KOLN (DE); ULRICH PLUTOWSKI, DORMAGEN (DE); MATTHIAS BIENMULLER, KREFELD (DE)

(73) Assignee: LANXESS DEUTSCHLAND GMBH, COLOGNE (DE)

(21) Appl. No.: 15/498,615

(22) Filed: Apr. 27, 2017

(30) Foreign Application Priority Data
Apr. 28, 2016 (EP) 16167451.0
Jul. 29, 2016 (EP) 16181874.5

(51) Int. Cl. C08L 67/02; B29C 47/00; B05D 1/04; B29K 67/00; B29K 69/00; B29L 31/30

(52) U.S. Cl. CPC C08L 67/02; B29C 47/0004; B29C 47/0011; B29C 47/0038; B05D 1/04; B29K 2069/00; B29L 2031/3055; C08L 2205/03; C08L 2205/06; B29K 2067/006

(57) ABSTRACT

The invention relates to polymer compositions, moulding compositions produced therefrom, and to products which are in turn based on the moulding compositions, where the polymer compositions include polybutylene terephthalate and/or polyalkylene furanoate, polycarbonate, and at least one secondary alkanesulphonate.

The invention relates to polymer compositions, moulding compositions produced therefrom, and to products which are in turn based on the moulding compositions, wherein the polymer compositions comprise polybutylene terephthalate or polyalkylene furanoate, polycarbonate, and at least one secondary alkanesulphonate.

### BACKGROUND INFORMATION

It is known from Kunststoffe, Eigenschaften und Anwendungen, H. Domininghaus et. al. 2008, chapter 21 Synthetische Kunststoffe, Polykondensate [Synthetic Plastics, polycondensates], p. 874, 2008, Verlag Springer (ISBN 978-3-540-72400-1) that products based on polybutylene terephthalate (PBT) can be coated with various coating systems, examples being hydro soft coatings. There are also known printing and coating systems for the motor vehicle industry which permit on-line coating of PBT up to 160° C.

According to Standothek, Kunststoffe und ihre Lackierung [Plastics and coating thereof], product brochure from Standox, Wuppertal, D12185782 D1007 5500, numerous problems can arise during coating, and these in turn are dependent on a wide variety of parameters. The following are just a few examples that may be mentioned here: inadequate pretreatment, unsuitable solvents, coating too soon after cleaning of the product to be coated, adhesion problems due to unsuitable adhesion promoters, flow problems due to unsuitable solvents, etc. PBT-based products are found mainly in the external bodywork parts of motor vehicles, in particular in wheel surrounds and hatchback doors, i.e. visible vehicle components where particularly good coating is important.

WO 2016/022243 A1, WO 02/48263 A2 and U.S. Pat. No. 4,226,961 A disclose compositions comprising PBT, polycarbonate (PC), and also at least one aromatic sulphonate, specifically potassium 3-(phenylsulphonyl)benzenesulphonate, tetrabutylphosphonium dodecylbenzenesulphonate and sodium 2,4,5-trichlorobenzenesulphonate. CN 104693745 A discloses flame-retardant PC/PBT mixtures to which 40% by weight of benzenesulphonate or alkylbenzenesulphonate are added in order to prevent electrostatic charging.

It was an object of the present invention to provide compositions based on polybutylene terephthalate (PBT) for moulding compositions and products based thereon which by virtue of their chemical composition reduce the occurrence of coating defects described above and thus provide more freedom to coaters in the selection of the coating system to be used for electrostatic spraying (ESTA).

### SUMMARY OF THE INVENTION

The object is achieved, and the invention provides, polymer compositions, moulding compositions to be produced therefrom, and products in turn to be produced from the moulding compositions, wherein the polymer compositions comprise
A) at least one of polybutylene terephthalate and polyalkylene furanoate, preferably polybutylene terephthalate,
B) polycarbonate, and
C) at least one secondary alkanesulphonate.

Surprisingly, when products based on the compositions of the invention are compared with similar products of other compositions they exhibit significantly reduced surface resistivity and therefore have excellent suitability for products which are coated after production thereof, in particular for products which are coated by electrostatic spraying (ESTA). Another feature of products of the invention is increased surface tension, reaching a level that allows use of ESTA to coat the said products in a continuous process on coating lines.

It should be noted for the avoidance of doubt that the scope of this present invention encompasses all of the definitions and parameters specified in general terms or in preferred ranges below, in any desired combinations.

Surface resistivity is a measure of ability to provide resistance to electrical current flowing on the surface of the plastics moulding. This property is dependent on the ambient conditions and on the test sample. Factors that have a decisive effect on determination of surface resistivity are humidity, contamination of the test sample surface, test sample size, and also electrode shape and electrode arrangement. The electrostatic characteristics of plastics are dependent on the surface resistivity of the material; DIN EN 61340-5-1 provides a list of individual properties.

Surface resistance in Ω [ohms] was determined in accordance with DIN IEC 60093 on discs of the test material with diameter 50 mm Ø and 1.5 mm. Silver electrodes were metallized onto the disc for this purpose. Surface resistance serves for the purposes of the present invention to characterize the suitability of coatings for use on products of the invention. Conventional deposition tests using by way of example electrocoat materials on products to be coated by ESTA are monitored in the laboratory via the current-time curve. Integral properties are thus determined. The surface resistance increase associated with the build-up of the coating layer, and the reduced electrical current, allow achievement of relatively uniform coating layer thicknesses, even on objects of complicated shape. The term used for the layer thickness ratio of internal regions to external regions of bodies of complicated shape is throw. Throw behaviour is tested in specific test rigs: for the purposes of the present invention the BMW throw system in accordance with VDA 621180 is used. See in this regard: A. Goldschmidt and H.-J. Streitberger, BASF-Handbuch Lackiertechnik [BASF Coating Technology Handbook], BASF Coatings AG, Vincentz Verlag, Hannover, 2002, pp. 504-507.

For the purposes of the present invention “alkyl” means a straight-chain or branched saturated hydrocarbon group. If by way of example an alkyl group or polyalkylene group having from 1 to 4 carbon atoms is used, this can be termed a “lower alkyl group” and can preferably comprise methyl (Me), ethyl (Et), propyl, in particular n-propyl and isopropyl, butyl or in particular n-butyl, isobutyl, sec-butyl or tert-butyl.

The person skilled in the art understands that compounding (compound=mixture) is a plastics technology term which describes the process that increases the value of plastics via admixture of additional substances (fillers, additives, etc.) for specific optimization of property profiles. Compounding preferably takes place in extruders, particularly preferably in corotating twin-screw extruders, counter-rotating twin-screw extruders, planetary-gear extruders or co-kneaders, and comprises the process operations of conveying, melting, dispersing, mixing, devolatizing and pressurizing. See also: http://de.wikipedia.org/wiki/Compoundierung.

The standards specified in the context of this application relate to the version in force at the date of filing of this invention.

### DETAILED DESCRIPTION OF THE INVENTION

Component A)

In an embodiment, component A) may be polybutylene terephthalate (PBT) [CAS No. 24968-12-5] and may be produced by known methods from terephthalic acid or reactive derivatives thereof and butanediol (Kunststoff-Handbuch [Plastics Handbook], Vol. VIII, pp. 695 ff., Karl Hanser Verlag, Munich 1973).

The PBT to be used as component A) preferably comprises at least 80 mol %, preferably at least 90 mol %, based on the dicarboxylic acid, of terephthalic acid moieties.

In one embodiment, the PBT to be used according to the invention as component A) can comprise not only terephthalic acid moieties but also up to 20 mol % of moieties of other aromatic dicarboxylic acids having from 8 to 14 carbon atoms or moieties of aliphatic dicarboxylic acids having from 4 to 12 carbon atoms, in particular moieties of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid, cyclohexanedicarboxylic acid or 2,5-furanedicarboxylic acid.

In one embodiment, the PBT to be used according to the invention as component A) can comprise not only butanediol but also up to 20 mol % of other aliphatic dials having from 3 to 12 carbon atoms or up to 20 mol % of cycloaliphatic dials having from 6 to 21 carbon atoms, preferably moieties of propane-1,3-diol, 2-ethylpropane-1,3-diol, neopentyl glycol, pentane-1,5-diol, hexane-1,6-dial, 1,4-cyclohexanedimethanol, 3-methylpentane-2,4-diol, 2-methylpentane-2,4-diol, 2,2,4-trimethylpentane-1,3-diol, 2,2,4-trimethylpentane-1,5-diol, 2-ethylhexane-1,3-diol, 2,2-diethylpropane-1,3-diol, hexane-2,5-diol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(3-β-hydroxyethoxyphenyl)propane and 2,2-bis(4-hydroxypropoxyphenyl)propane.

The intrinsic viscosity of PBT preferably to be used as component A) is in the range from 30 to 150 cm³/g in accordance with EN ISO 1628/5, particularly preferably in the range from 40 to 130 cm³/g, very particularly preferably in the range from 50 to 100 cm³/g, measured in each case in an Ubbelohde viscometer in phenol/o-dichlorobenzene (1:1 part by weight) at 25° C. According to the Mark-Houwink equation, intrinsic viscosity IV, also termed Staudinger Index or limiting viscosity, is proportional to average molecular mass, and is the extrapolation of viscosity number VN to zero polymer concentration. It can be estimated from series of measurements or via use of suitable approximation methods (e.g. Billmeyer). VN [ml/g] is obtained from solution viscometry measured in a capillary viscometer, for example Ubbelohde viscometer. Solution viscosity is a measure of the average molecular weight of a plastic. The value is determined on polymer in solution, using various solvents, preferably formic acid, m-cresol, tetrachloroethane, phenol, 1,2-dichlorobenzene, etc., and various concentrations. The viscosity number VN can be used to monitor the processing characteristics and usage characteristics of plastics. Comparative measurements can be used to study thermal stressing of the polymer, ageing phenomena or the effect of chemicals, weathering and light. In this regard see also: http://de.wikipedia.org/wiki/Viskosimetrie and http://de.wikipedia.org/wiki/Mark-Houwink-Gleichung.

The PBT preferably to be used according to the invention as component A) can also be used in a mixture with other polymers. PBT blends to be used according to the invention are produced by compounding. During this compounding it is moreover possible to admix, in the melt, conventional additives, particularly mould-release agents or elastomers, thus improving the characteristics of the blends.

PBT preferably to be used according to the invention can be purchased as Pecan® B 1300 from Lanxess Deutschland GmbH, Cologne.

In an alternative embodiment at least one polyalkylene furanoate, preferably polyethylene furanoate (PEF) or polypropylene furanoate (PPF), can be used as component A). Polyalkylene furanoates are preferably obtained from recycling processes involving polymerization of 2,5-furanedicarboxylic acid. Hydroxymethylfurfural (HMF); Avantium, Amsterdam, The Netherlands, is used as starting material. See also: BioPla Journal, No. 59, 2015, pp. 12-17.

In an embodiment, the polymer composition may contain about 10 to about 85% by weight of component A) the polybutylene terephthalate and/or polyalkylene furanoate.

Component B)

According to the invention, component A) is used in combination with component B) polycarbonate (PC). It is preferable that components A) and B) take the form of blend. It is preferable to use polycarbonate based on 2,2-bis(4-hydroxyphenyl)propane (bisphenol A), bis(4-hydroxyphenyl) sulphone (bisphenol S), dihydroxydiphenyl sulphide, tetramethylbisphenol A, 1,1-bis(4-hydroxyphenyl)-3,3,5-trimethylcyclohexane (BPTMC) or 1,1,1-tris(4-hydroxyphenyl)ethane (THPE). In particular it is preferable to use PC based on bisphenol A [CAS No. 25037-45-0]. PBT-PC blends to be used according to the invention are produced by compounding. During this compounding it is moreover possible to admix, in the melt, conventional additives, particularly mould-release agents or elastomers, thus improving the characteristics of the blends. Polycarbonate which is in particular preferably to be used according to the invention and is based on bisphenol A can be purchased as Makrolon® 2405 from Covestro AG, Leverkusen.

In an embodiment, the polymer composition may contain about 15 to about 90% by weight of component B)—the polycarbonate.

Component C)

Sodium salts of secondary alkanesulphonates (SAS) are used as component C). Sulphonic acids in which the group R is aliphatic are termed alkanesulphonic acids, and salts and esters of these are termed alkylsulphonates or alkanesulphonates. Secondary alkanesulphonates to be used according to the invention as component C) feature a secondary carbon atom which bears not only the sulphonate moiety but also two alkyl moieties and therefore not aromatic moiety—as in the prior art described above.

Particularly in Europe, SAS [CAS No. 97489-15-1] are an economically important group of anionic surfactants, and are characterized by a mixture of isomers and homologues of the general formula (I)

R¹—HC(SO₃Na)—R² (I)

in which R¹ and R² are respectively mutually independently a C₁₀ to C₂₁ alkyl moiety. Particular preference is given to sodium salts of the alkanesulphonic acid of the formula (I) in which R¹ and R² are mutually independently respectively a C₁₆-C₁₈ alkyl moiety.

SAS is obtained by sulphoxidation or sulphochlorination of straight-chain paraffins with subsequent neutralization or sulphonification of the sulphochlorides by means of sodium hydroxide solution. SAS have very good biodegradability, and have hitherto been used mainly in dishwashing compositions and household cleaning products, and also in bodycare compositions, in emulsion polymerization and in fire-extinguishing compositions. Other terms conventionally used for SAS which are marketed with the trademark Mersolat® by Lanxess Deutschland GmbH, Cologne are phenyl (C₁₀-C₂₁) alkanesulphonate and phenyl (C₁₆-C₁₈) alkanesulphonate. See also
https://de.wikipedia.org/wiki/(C10%E2%80%93C21)Alkansulfons%C3%A4urephenylester.

The quantities of SAS preferably used are from 0.5 to 20 parts by weight, based on 100 parts by weight of component A). SAS which is preferably to be used in the invention can be purchased by way of example as Mersolat® H95 from Lanxess Deutschland GmbH, Cologne.

Component D)

In a preferred embodiment, component D) at least one elastomer modifier is also used in addition to components A), B) and C). Quantities preferably used of component D) are from 1 to 35 parts by weight, based on 100 parts by weight of component A). Elastomer modifiers preferably to be used as component D) comprise inter alia one or more graft polymers of

D.1 preferably from 5 to 95% by weight, particularly preferably from 30 to 90%, of a one vinyl monomer on

D.2 preferably from 95 to 5% by weight, particularly preferably from 70 to 10% by weight, of one or more graft bases with glass transition temperatures <10° C., preferably <0° C., particularly preferably <−20° C. The percentages by weight are based on 100 percent by weight of D).

The median particle size (d50 value) of the graft base D.2 is generally in the range from 0.05 to 10 μm, preferably in the range from 0.1 to 5 μm, particularly preferably in the range from 0.2 to 1 μm.

Monomers D.1 are preferably mixtures of

D.1.1 from 50% to 99% by weight of vinylaromatics and/or ring-substituted vinylaromatics, in particular styrene, α-methylstyrene, p-methylstyrene, p-chlorostyrene, and/or (C₁-C₈) alkyl methacrylate, in particular methyl methacrylate or ethyl methacrylate, and

D.1.2 from 1% to 50% by weight of vinyl cyanides, in particular unsaturated nitriles such as acrylonitrile and methacrylonitrile, and/or (C₁-C₈-alkyl (meth)acrylate, in particular methyl methacrylate, glycidyl methacrylate, n-butyl acrylate, ten-butyl acrylate, and/or derivatives, in particular anhydrides and imides of unsaturated carboxylic acids, in particular maleic anhydride or N-phenylmaleimide. The percentages by weight here are based on 100% by weight of D1.

Preferred monomers D.1.1 are selected from at least one of the monomers styrene, α-methylstyrene and methyl methacrylate; preferred monomers D.1.2 are selected from at least one of the monomers acrylonitrile, maleic anhydride, glycidyl methacrylate and methyl methacrylate.

Particularly preferred monomers are D.1.1 styrene and D.1.2 acrylonitrile.

Graft bases D.2 suitable for the graft polymers to be used in the elastomer modifiers are by way of example diene rubbers, EPDM rubbers, i.e. rubbers based on ethylene/propylene and optionally on diene, and also acrylate rubbers, polyurethane rubbers, silicone rubbers, chloroprene rubbers and ethylene/vinyl acetate rubbers. EPDM is ethylene-propylene-diene rubber.

Preferred graft bases D.2 are diene rubbers, in particular based on butadiene, isoprene, etc., or are mixtures of diene rubbers, or are copolymers of diene rubbers or of mixtures of these with other copolymerizable monomers, in particular according to D.1.1 and D.1.2, with the proviso that the glass transition temperature of component D.2 is <10° C., preferably <0° C., particularly preferably <−10° C.

Particularly preferred graft bases D.2 are ABS polymers (emulsion, bulk and suspension ABS), where ABS is acrylonitrile-butadiene styrene as described by way of example, in DE-A 2 035 390 (=U.S. Pat. No. 3,644,574) or in DE-A 2 248 242 (=GB-A 1 409 275) and Ullmann, Enzyklopädie der Technischen Chemie [Ullmann, Encyclopaedia of Industry Chemistry], Vol. 19 (1980), p. 280 ff. The gel content of the graft base D.2 is preferably at least 30% by weight, particularly preferably at least 40% by weight (measured in toluene). Very particular preference is given to a rubber based on an acrylonitrile-butadiene styrene copolymer, obtainable by way of example as Novodur® P60 from Ineos Styrolution Group, Frankfurt.

The elastomer modifiers or graft polymers are produced by free-radical polymerization, preferably emulsion polymerization, suspension polymerization, solution polymerization or bulk polymerization, in particular by emulsion polymerization or bulk polymerization.

Other particularly suitable graft rubbers are ABS polymers which are produced by redox initiation using an initiator system made of organic hydroperoxide and ascorbic acid according to U.S. Pat. No. 4,937,285.

It is known that the graft monomers are not necessarily entirely grafted onto the graft base during the grafting reaction, and the expression graft polymers according to the invention therefore includes products which are obtained via (co)polymerization of the graft monomers in the presence of the graft base and are concomitantly present in the worked-up product.

Acrylate rubbers that are likewise suitable are based on graft bases D.2 which preferably comprise polymers of alkyl acrylates, optionally with up to 40% by weight, based on D.2, of other polymerizable, ethylenically unsaturated monomers. Among the preferred polymerizable acrylates are C₁-C₈ alkyl esters, preferably methyl, ethyl, butyl, n-octyl and 2-ethylhexyl esters; haloalkyl esters, preferably halo-C₁-C₈ alkyl esters, preferably chloroethyl acrylate, glycidyl esters, and also mixtures of these monomers. Particular preference is given here to graft polymers with butyl acrylate as core and methyl methacrylates as shell, in particular Paraloid® EXL2300, Dow Corning Corporation, Midland Mich., USA.

Other preferably suitable graft bases according to D.2 are silicone rubbers having graft active sites, as described in DE-A 3 704 657 (=U.S. Pat. No. 4,859,740), DE-A 3 704 655 (=U.S. Pat. No. 4,861,831), DE-A 3 631 540 (=U.S. Pat. No. 4,806,593) and DE-A 3 631 539 (=U.S. Pat. No. 4,812,515).

Preferred graft polymers with silicone content are those having methyl methacrylate or styrene-acrylonitrile as shell and a silicone/acrylate graft as core. Among these materials with styrene-acrylonitrile as shell, an example that can be used is Metablen® SRK200. Among these materials with methyl methacrylate as shell, examples that can be used are Metablen® S2001, Metablen® S2030 and/or Metablen® SX-005. Particular preference is given to use of Metablen® S2001. The products with the trademarks Metablen® are obtainable from Mitsubishi Rayon Co., Ltd., Tokyo, Japan.

Crosslinking may be achieved by copolymerizing monomers comprising more than one polymerizable double bond. Preferred examples of crosslinking monomers are esters of unsaturated monocarboxylic acids having from 3 to 8 carbon atoms and unsaturated monohydric alcohols having from 3 to 12 carbon atoms or of saturated polyols having from 2 to 4 OH groups and from 2 to 20 carbon atoms, preferably ethylene glycol dimethacrylate, allyl methacrylate; polyunsaturated heterocyclic compounds, preferably trivinyl cyanurate and triallyl cyanurate; polyfunctional vinyl compounds, preferably di- and trivinylbenzenes; and also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloylhexahydro-s-triazine and triallylbenzenes. The quantity of the crosslinked monomers is preferably from 0.02 to 5% by weight, in particular from 0.05 to 2% by weight, based on the graft base D.2.

When cyclic crosslinking monomers have at least 3 ethylenically unsaturated groups it is advantageous to restrict the quantity to less than 1% by weight of the graft base D.2.

Preferred “other” polymerizable, ethylenically unsaturated monomers which can optionally be used alongside the acrylates for the production of graft base D.2 are acrylonitrile, styrene, α-methylstyrene, acrylamides, vinyl-C₁-C₆ alkyl ethers, methyl methacrylate, glycidyl methacrylate and butadiene. Preferred acrylate rubbers as graft base D.2 are emulsion polymers having at least 60% by weight gel content.

Other materials that can likewise be used, alongside elastomer modifiers based on graft polymers, are elastomer modifiers which are not based on graft polymers and have glass transition temperatures <10° C., preferably <0° C., particularly preferably <−20° C. Among these are preferably elastomers with block copolymer structure, and also moreover elastomers that can undergo thermoplastic melting, in particular EPM rubbers, EPDM rubbers and/or SEBS rubbers (EPM=ethylene-propylene copolymer, EPDM=ethylene-propylene-diene rubber and SEBS=styrene-ethene-butene-styrene copolymer).

Component E)

Compositions of the invention also comprise, as component E), in addition to components A), B), C) and D), or instead of D), at least one filler or reinforcement material. The quantity of fillers or reinforcing materials used for every 100 parts by weight of component A) is preferably in the range from 1 to 55 parts by weight.

It is preferable to use at least one filler or reinforcing material from the group of mica, silicate, quartz, in particular powdered quartz, talc powder [CAS No. 14807-96-6], titanium dioxide, amorphous silicas, barium sulphate, glass beads, powdered glass and/or fibrous fillers and/or reinforcing materials based on glass fibres or carbon fibres.

It is particularly preferable to use talc powder, glass beads or powdered glass, and it is very particularly preferable to use glass beads. When glass beads are used, data relating to particle size distribution or to particle sizes relate to what are known as surface-based particle sizes, in each case prior to incorporation to the thermoplastic moulding composition. The procedure here is to calculate the relationship between the diameters of the surface areas of the respective glass particles and the surface areas of imaginary spherical particles (beads). This is accomplished with a particle size analyser from Ankersmid (Eye Tech® including the EyeTech® software and ACM-104 measurement cell, Ankersmid Lab, Oosterhout, the Netherlands), which uses the laser obscuration principle of operation.

As a result of processing to give the moulding composition or to give a product, the d97 value or d50 value of any of the fillers and/or reinforcing materials to be used as component E) can be smaller in the said materials than in the fillers or reinforcing materials originally used.

In respect of the d50 and d97 values in this application, determination thereof and significance thereof, reference may be made to Chemie Ingenieur Technik (72) pp. 273-276, 3/2000, Wiley-VCH Verlags GmbH, Weinheim, 2000, according to which

the d50 value is that particle size for which 50% of the particles lie below the said size (median) value and the

d97 value is that particle size for which 97% of the particles lie below the said size.

The fillers and reinforcing materials can be used individually or in the form of mixture of two or more different fillers and/or reinforcing materials.

In a preferred embodiment the filler and/or reinforcing material to be used as component E) can have been surface-modified, particularly preferably with a coupling agent or coupling agent system, with particular preference one based on epoxide. However there is no essential requirement for pretreatment.

In a particularly preferred embodiment, spherical glass beads, known as Spheriglass, are used as component E).

The fillers and/or reinforcing materials, in particular glass beads or glass fibres, to be used as component E) are preferably equipped with a suitable size system or with a coupling agent or coupling agent system, particularly preferably one based on silane.

Very particularly preferred silane-based coupling agents far the above pretreatment are silane compounds of the general formula (II)

(X—(CH₂)_{q})ₖ—Si—(O—CᵣH₂ᵣ₊₁)₄-k (II)

in which the substituents are defined as follows:
X NH₂—, HO—,

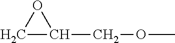

q: an integer from 2 to 10, preferably from 3 to 4,
r: an integer from 1 to 5, preferably from 1 to 2,
k: an integer from 1 to 3, preferably 1.

Particularly preferred coupling agents are silane compounds from the group of aminopropyltrimethoxysilane, aminobutyltrimethoxysilane, aminopropyltriethoxysilane, aminobutyltriethoxysilane and the corresponding silanes comprising a glycidyl group as substituent X.

Quantities used of the silane compounds for surface-coating treatment of the glass beads or glass fibres are preferably in the range from 0.05 to 2% by weight, particularly preferably in the range from 0.25 to 15% by weight and in particular in the range from 0.5 to 1% by weight, based on the filler or reinforcing material.

Glass beads to be used according to the invention can be purchased as Spheriglass® 3000 CP02 from Potters Industries LLC, Valley Forge, Pa. 19482, USA.

Component F)

In a preferred embodiment, component F) at least one further additive is also used in addition to components A), B), C), D) and/or E), or instead of D) or instead of E). Quantities preferably used of component F) are from 0.1 to 20 pans by weight based on 100 parts by weight of polyester of component A).

Preferred further additives for the purposes of the present invention are UV stabilizers, heat stabilizers, lubricants and mould-release agents, fillers and reinforcing materials differing from component E), nucleating agents, laser absorbers, di- or polyfunctional branching or chain extending additives, hydrolysis stabilizers, antistatic agents, emulsifiers, plasticizers, processing aids, flow aids, elastomer modifiers differing from component D) and colorants. Each of the additives can be used alone or in a mixture or in the form of masterbatch.

Preferred lubricants and mould-release agents are those selected from the group of the long-chain fatty acids, the salts of long-chain fatty acids, the ester derivatives of long-chain fatty acids, and also montane waxes.

Preferred long-chain fatty acids are stearic acid and behenic acid. Preferred salts of the long-chain fatty acids are Ca stearate and Zn stearate. Preferred ester derivatives of long-chain fatty acids are those based on pentaerythritol, in particular C₁₆-C₁₈ fatty acid esters of pentaerythritol [CAS No. 68604-44-4] or [CAS No. 85116-93-4].

For the purposes of the present invention, montane waxes are mixtures of straight-chain, saturated carboxylic acids having chain lengths of from 28 to 32 carbon atoms. According to the invention, particular preference is given to lubricants and/or mould-release agents from the group of the esters of saturated or unsaturated aliphatic carboxylic acids having from 8 to 40 carbon atoms with aliphatic saturated alcohols having from 2 to 40 carbon atoms, and also to metal salts of saturated or unsaturated aliphatic carboxylic acids having from 8 to 40 carbon atoms, very particular preference being given here to pentaerythritol tetrastearate, calcium stearate [CAS No. 1592-23-0] and/or ethylene glycol dimontanate, and in this case in particular Licowax® E [CAS No. 74388-22-0] from Clariant, Muttenz, Basle, and very particular preference in particular given to pentaerythritol tetrastearate [CAS No. 115-83-3], obtainable by way of example as Loxiol® P861 from Emery Oleochemicals GmbH, Dusseldorf, Germany.

Colorants used are preferably organic pigments, preferably phthalocyanines, quinacridones, perylenes and also dyes, preferably nigrosin or anthraquinones, and also inorganic pigments, in particular titanium dioxide and/or barium sulphate, ultramarine blue, iron oxide, zinc sulphide or carbon black.

Plasticizers preferably to be used as component F) are dioctyl phthalate, dibenzyl phthalate, butyl benzyl phthalate, hydrocarbon oils or N-(n-butyl)benzenesulphonamide.

Nucleating agents preferably used are sodium acetate, sodium salicylate, sodium stearate, sodium saccharinate, potassium acetate, potassium salicylate, potassium stearate, potassium saccharinate, and also partially hydrolysed montane waxes and ionomers, and also very particularly preferably talc powder, in so far as not already present as component E); this list is not exclusive.

Heat stabilizers preferably to be used as component F) are selected from the group of the sterically hindered phenols and aliphatically or aromatically substituted phosphites and variously substituted members of these groups.

Among the sterically hindered phenols, it is preferable to use those having at least one 3-tert-butyl-4-hydroxy-5-methylphenyl unit and/or at least one 3,5-di(tert-butyl-4-hydroxyphenyl) unit, particular preference being given to 1,6-hexanediol bis[3-(3,5-di-tert-butyl-4-hydroxyphenyl)propionate] [CAS No. 35074-77-2] (Irganox® 259 from BASF SE, Ludwigshafen, Germany), pentaerythritol tetrakis[3-(3,5-di-tert-butyl-4-hydroxyphenyl)propionate] [CAS No. 6683-19-8] (Irganox® 1010 from BASF SE) and 3,9-bis[2-[3-(3-tert-butyl-4-hydroxy-5-methylphenyl)propionyloxy]-1,1-dimethylethyl]-2,4,8,10-tetraoxaspiro[5.5]undecane [CAS No. 90498-90-1] (ADK Stab® AO 80). ADK Stab® AO 80 is a product available commercially from Adeka-Palmerole SAS, Mulhouse, France.

Among the aliphatically or aromatically substituted phosphites, it is preferable to use Tetrakis(2,4-di-tert-butylphenyl) 4,4-biphenyldiphosphonite [CAS No. 119345-01-6], supplied by way of example as Hostanox® P-EPQ by Clariant International Ltd, Muttenz, Switzerland, bis(2,4-dicumylphenyl) pentaerythritol diphosphite [CAS No. 154862-43-8], supplied by way of example with trademark Doverphos® S9228 by Dover Chemical Corp., Dover, USA, and/or Tetrakis(2,4-di-tert-butylphenyl) 1,1-biphenyl-4,4′-diylbisphosphonite [CAS No. 38613-77-3].

In a preferred embodiment, the present invention provides compositions and moulding compositions to be produced therefrom, and also products comprising A) polybutylene terephthalate, B) polycarbonate and C) at least one compound of the formula R¹—HC(SO₃Na)—R², in which R¹ and R² are respectively mutually independently a C₁₀-C₂₁ alkyl moiety.

In a preferred embodiment, the present invention provides compositions and moulding compositions to be produced therefrom, and also products comprising A) polybutylene terephthalate, B) polycarbonate, C) at least one compound of the formula R¹—HC(SO₃Na)—R², in which R¹ and R² are respectively mutually independently a C₁₀-C₂₁ alkyl moiety, and E) at least one rubber based on acrylonitrile-butadiene-styrene copolymer.

Use

However, the present invention also provides the use of the compositions of the invention, in particular in the form of moulding compositions, for the production of products which are subjected to an electrostatic spray process (ESTA).

Coating

Coating can be regarded as the most important process for the application of a covering on products from industrial production. A very wide variety of coating processes have therefore been developed for industrial use. Use of substantially automated systems also permits rapid and uniform coating of large numbers of components by spraying processes, casting processes, rolling processes or immersion processes. Coating processes encompassed according to the invention are those from the group of low-pressure spraying, compressed-air spraying, very-high-pressure spraying, hot spraying, electrostatic spraying, clip coating, casting processes and rolling processes.

Composition of Coatings

Paints and coatings are mixtures of binders, pigments, solvents and diluents, fillers and other added substances. Binders have the task of bonding the pigment particles to one another and to the substrate to be coated. Pigments are inorganic or organic, chrominate or nonchrominate colorants that are practically insoluble in the application medium. Solvents and diluents (e.g. petroleum spirit or terpentin oil) are a liquid which is composed of one or more components and which is capable of dissolving the binder without chemical reaction. This gives the coating the viscosity required for processing. Fillers are pulverulent substances which are practically insoluble in the application medium which are used to modify volume, to achieve or improve technical characteristics and/or to influence optical properties. Other added substances are inter alia plasticizers, desiccants, hardeners wetting agents, and also matting agents. Plasticizers are important constituents for coatings that are subsequently applied to components that are to undergo forming processes. Hardeners are constituents of scratch-resistant coatings.

Pretreatment of Workpiece Surfaces

Before organic coating, the surfaces of the products to be coated mostly require treatment in order to ensure good adhesion of the coating layer on the substrate, a problem-free coating process, a uniform coating film, and also increased resistance to environmental effects. A distinction is drawn between mechanical and chemical pretreatment processes.

Coating Processes

In the case of spraying, the liquids are atomized. This can be achieved with the aid of various physical effects. Two principles of atomization are used in coating technology: atomization via mechanical forces (=mechanically assisted spray processes) and atomization via electrical forces (=electrically assisted spray processes).

The effectiveness of the various spray processes differs considerably. The term overspray is used for spray that is not deposited on the target or is deflected therefrom, and this can lead to poor cost-effectiveness of the process due to substantial losses of coating material, and to pollution of the environment. Many different nozzle types are supplied for manual and automatic spray guns for the coating process, examples being the tangential hollow cone nozzle, the axial full cone nozzle, the hollow cone helix nozzle, the cluster head nozzle, the pneumatic atomizer with external mixing and the ultrasonic-pneumatic atomizer with internal mixing. Atomizer nozzles generally used for applying coatings are those that provide full coverage of the area to be traversed. A section through a pneumatic atomizer reveals that the comminution of the coating material into droplets, and also onward transport, is brought about by air streams discharged at various positions. Nozzles operating with gas and liquid are termed two-fluid nozzles.

The most commonly used coating processes are briefly presented and described below.

Low-Pressure Spraying:

This process uses specific low-pressure spray equipment (“electrical spray guns”) operating with a spray pressure of from 0.2 to 03 bar. In this process the air is not compressed as in the compressed-air process, but instead is passed immediately to the gun from a rotary blower, with no intervening air chamber. The process is generally used where the coating is not subject to any major requirements for optical properties. It is suitable for the processing of thin or highly diluted coating materials.

In the case of compressed-air spraying, distribution and application of the coating material is achieved via compressed air (at from 1 to 5 bar), which has to be free from water and oil. This process uses spray guns in which the compressed air flows at high velocity. A nozzle system is used for suction intake of the coating material, which is atomized in a spray cone which can be adjusted to the respective requirements. Compressed-air spraying permits spraying of pigment-rich, low-solvent-content coating materials of fairly high viscosity.

Very-High-Pressure Spraying (Airless Spraying):

In this process, the coating material is forced hydraulically under a pressure of about 100 to 400 bar through the spray nozzle, without admixture of air. The said high pressure is generated by a compressed-air-operated or electrically operated piston pump. Atomization takes place on discharge from the nozzle. Rapid expansion in combination with air resistance and mechanical resistance produces very small droplets. The jet of the coating material is free from air. The air delivered to the gun is used for servo control of the needle or for air-jet cleaning. The large throughput quantities make the process suitable for large coherent areas.

Hot spraying permits problem-free processing of highly viscous, low-solvent-content coating materials because the viscosity of the material decreases with increasing temperature. This process can use compressed-air atomization or airless atomization with or without support air. The material is heated to about 55 to 70° C. directly in the container of the gun or by way of heat exchangers with a system in which hot water or hot coating material circulates. Hot spraying can provide large individual layer thicknesses, and is often used in conjunction with the high-pressure spraying process.

Electrostatic Spraying (ESTA):

A direct voltage of from 30 kV to 50 kV is applied between the product to be coated and the spray gun, and leads to formation of a powerful electrical field. As soon as the coating material, preferably wet coating material (electrostatic wet coating) or powder coating material (electrostatic powder coating) is discharged from the gun, it becomes electrically charged and follows the field lines as if drawn by a magnet. The particles of coating material have charges of the same polarity, and they therefore repel one another during flight, producing a homogeneous spray jet. Deposition of the particle surface is equally uniform. By virtue of the large attractive force, particles which would normally pass over the target are also deflected and accelerated towards the workpiece.

If atomization is achieved mechanically, preferably by compressed-air spraying, airless spraying or rotary atomizer, the expression electrostatically assisted coating is used. The charging process here can take place within the spray unit (internal charging) or outside of the spray unit (external charging) (see also Corona charging). Because the particles of coating material substantially follow the course of the electrical field lines between charging electrode (atomizer) and counter electrode (earthed workpiece), electrostatically assisted coating of wet coating materials applies the material more effectively than processes without electrostatic assistance. As already described above, the effect known as throw is used to evaluate the capability of ESTA-coated products.

In the case of dip-coating, the products to be coated are immersed into the coating material and removed therefrom after they have been completely wetted. The products are immersed completely into the coating material, and are therefore not permitted to float, i.e. their density must be greater than that of the coating material. There must be no air bubbles remaining during immersion, because otherwise no coating material is applied at those locations. There must be no excess of coating material on the coated product when it is removed from the tank, because excessive quantities of coating material do not harden sufficiently. The products to be coated must also be completely clean before coating! Dip coating is suitable for the application of basecoat layers or topcoat layers where requirements are not stringent (e.g. for agricultural machinery).

Casting Processes:

Casting machines are large tables, the surface of which is composed of rolls or of conveyor belts which transport the article to be coated with variable velocity through the coating procedure. The coating material for this is pumped by a feed pump from a storage container into what is known as the casting head. This is a vessel which extends across the entire width of the conveyor system and which has an adjustable gap on the underside through which the paint flows in a wide continuous paint curtain vertically downwards or onto the workpiece. The casting process is particularly used for very large, flat or curved articles which cannot be coated by the roll process.

In the case of roll processes, the coating material is transferred from rotating rubber rolls onto the workpiece surface. The desired application quantities of coating material can be established by way of an adjustable gap between applicator roll and metering roll. Workpiece surfaces can be coated on one or both sides. In the case of the corotating roll process, workpiece and coating rolls move in the same direction; in the case of the auxiliary roll process they move in opposite directions. The roll process is used to coat metal strips, furniture parts, metal sheets, cans and buckets.

The present invention provides the use of products comprising compositions of the invention in the electrostatic spray process (ESTA).

The present invention moreover provides the use of coated products comprising the compositions of the invention in the motor vehicle industry, preferably as bodywork parts in motor vehicles, particularly preferably as wheel surrounds, bumpers, tank covers, spoilers, mirror housings, door handles, and also other panelling in the motor vehicle sector and heavy goods vehicle sector.

Production Process

However, the present invention also provides a process for the production of products, preferably for the motor vehicle industry, in that compositions of the invention are mixed to give a moulding composition. It is also possible that these moulding compositions are discharged in the form of a strand, cooled until they can be granulated, and are granulated before they are subjected to injection moulding.

The mixing preferably takes place at temperatures in the range from 240 to 310° C., preferably in the range from 260 to 300° C., particularly preferably in the range from 270 to 295° C., in the melt. In particular, it is preferable to use a twin-screw extruder for this purpose.

In one embodiment, the granulate which comprises the composition of the invention is dried, preferably at temperatures in the region around 120° C. in a vacuum drying oven or in a pneumatic dryer for a period of 2 h, before it is subjected to injection moulding for purposes of production of products of the invention and then subjected to a coating process.

The processes for the injection moulding of PBT-based moulding compositions are known to the person skilled in the art.

Processes of the invention for the production of PET-based products by injection moulding operate at melt temperatures in the range from 240 to 330° C., preferably in the range from 260 to 300° C., particularly preferably in the range from 270 to 290° C., and optionally also at pressures of at most 2500 bar, preferably at pressures of at most 2000 bar, particularly preferably at pressures of at most 1500 bar and very particularly preferably at pressures of at most 750 bar.

Features of the injection moulding process are that the moulding composition comprising the compositions of the invention, preferably in granulate form, is melted(plastified) in a heated cylindrical cavity and, as injection moulding composition, is injected under pressure into a temperature-controlled cavity. The injection moulding is demoulded after cooling (solidification) of the composition.

The various phases are:
1. Plastification/melting
2. injection phase (charging procedure)
3. Hold-pressure phase (to allow for thermal contraction during crystallization)
4. Demoulding.

In this connection, see http://de.wikipedia.org/wiki/Spritzgie%C3%9Fen. An injection moulding machine is composed of a clamping unit, the injection unit, the drive and the control system. The clamping unit comprises fixed and movable platens for the mould, an end platen, and also tie bars and drive for the movable mould platen (toggle assembly or hydraulic clamping unit).

An injection unit comprises the electrically heatable cylinder, the screw drive (motor, gearbox) and the hydraulic system for displacing the screw and the injection unit. The function of the injection unit consists in melting, metering and injecting the powder or the granulate (to allow for contraction). The problem of reverse flow of the melt within the screw (leakage flow) is solved via non-return valves.

Within the injection mould, the inflowing melt is then separated and cooled, thus giving the required product. Two mould halves are always necessary for this purpose. The various functional systems involved in the injection moulding process are:
Runner system
Shaping inserts
Vents
System for retaining machine and withstanding forces
Demoulding system and motion transmission
Temperature control.

It will be understood that the specification and examples are illustrative but not limitative of the present invention and that other embodiments within the spirit and scope of the invention will suggest themselves to those skilled in the art.

### Examples

Polyester moulding compositions were then manufactured by compounding in order to demonstrate the surprising properties found and the resultant possibilities for the coating of products based on the compositions of the invention. To this end, the individual components were mixed in a twin-screw extruder (ZSK 32 Mega Compounder from Coperion Werner & Pfleiderer (Stuttgart, Germany)) at temperatures in the range from 260 to 300° C., discharged in the form of strand, are cooled until they can be granulated, and are granulated. After drying (generally for 2 h at 120° C. in a vacuum drying oven), the granulate was processed to give test samples.

The test samples for the studies listed in Table 1 were injection moulded in an Arburg 320-210-500 injection moulding machine at melt temperature 260° C. and mould temperature 80° C.:
Discs, diameter 80 mm, thickness 4 mm

### Materials Used in the Examples

Component A): Linear polybutylene terephthalate (Pocan® B 1300, product commercially available from Lanxess Deutschland GmbH, Leverkusen, Germany) with intrinsic viscosity of 93 cm³/g (measured in phenol: 1,2-dichlorobenzene=1:1 at 25° C.)

Component B): Makrolon® 2405 polycarbonate from Covestro AG

Component C): Mersolat® H95, SDB No. 011693, sodium alkanesulphonate [CAS No. 68188-18-1], obtainable from Lanxess Deutschland GmbH, Cologne

Component D): Novodur® P60, acrylonitrile-butadiene-styrene copolymer, obtainable from INEOS Styrolution Group, Frankfurt

Component F) Other additives commonly used in polyesters, examples being mould-release agents (e.g. pentaerythritol tetrastearate (PETS)), heat stabilizers, e.g. those based on phenyl phosphites, for example pentaerythrilol tetrakis[3-(3,5-di-tert-butyl-4-hydroxyphenyl)propionate] [CAS No. 6683-19-8] (Irganox® 1010 from BASF SE) and nucleating agents, for example: Mistron® R10 talc obtainable from Imerys Talc Group, Toulouse, France. The nature and quantity of the additives constituting component F are the same for Inventive Examples and Comparative Examples.

The sum of the proportions of the components in Table 1 is always 100% by weight.

TABLE 1
(all quantities in % by weight)

| | Inventive | Inventive | Comp. |
|---|---|---|---|
| | Example 1 | Example 2 | Example 1 |
| A) | 46.2 | 42.2 | 49.2 |
| B) | 35.0 | 35.0 | 35.0 |
| C) | 3.0 | 7.0 | |
| D) | 15 | 15 | 15 |
| F] | 0.8 | 0.8 | 0.8 |
| Surface resistivity [ohms] | 7E+10 | 8E+09 | 4.90E+17 |
| Throw during ESTA coating | + | ++ | ∘ |

The Examples show that when component C) is used the effect is a reduction of surface resistivity of from 10⁷ to 10⁸ in comparison with the Comparative Example without component C). Because of the resulting increase of surface conductivity the material is amenable to electrostatic coating, in contrast to a material without component C). This can be demonstrated practically via good throw of the coating material on that side of the substrate that faces away from the coating gun. In contrast to this, material without component C) exhibits a lack of throw. Addition of component C) here has no adverse effect on mechanical properties, whereas other conductivity additives such as carbon black and carbon nanotubes (CNT) are known to have this type of adverse effect.

A combination of PBT as component A) with components B) and C) can usually be used in a continuous coating process. Time and costs can thus be saved. Finally, products based on compositions of the invention feature very low water absorption, ensuring dimensional stability irrespective of temperature/humidity conditions.

What is claimed is:

1. A composition comprising:
at least one of polybutylene terephthalate and polyalkylene furanoate;
polycarbonate; and
at least one secondary alkanesulphonate.

2. The composition according to claim 1, wherein the polyalkylene furanoate is polyethylene furanoate or polypropylene furanoate.

3. The composition according to claim 1, wherein the at least one secondary alkanesulphonate is a mixture of isomers and homologues of the general formula (I)
R¹—HC(SO₃Na)—R² (I),
in which R¹ and R² are mutually independently a C₁₀ to C₂₁ alkyl moiety.

4. The composition according to claim 3, wherein R¹ and R² are mutually independently a C₁₆-C₁₈ alkyl moiety.

5. The composition according to claim 1, wherein the polycarbonate comprises a polycarbonate based on 2,2-bis(4-hydroxyphenyl)propane, bis(4-hydroxyphenyl) sulphone, dihydroxydiphenyl sulphide, tetramethylbisphenol A, 1,1-bis(4-hydroxyphenyl)-3,3,5-trimethylcyclohexane, or 1,1,1-tris(4-hydroxyphenyl)ethane, preferably based on 2,2-bis(4-hydroxyphenyl)propane.

6. The composition according to claim 1, wherein:
the at least one secondary alkanesulphonate is a mixture of isomers and homologues of the general formula (I)
R¹—HC(SO₃Na)—R² (I),
in which R¹ and R² are mutually independently a C₁₀ to C₂₁ alkyl moiety; and
the polycarbonate comprises a polycarbonate based on 2,2-bis(4-hydroxyphenyl)propane, bis(4-hydroxyphenyl) sulphone, dihydroxydiphenyl sulphide, tetramethylbisphenol A, 1,1-bis(4-hydroxyphenyl)-3,3,5-trimethylcyclohexane, or 1,1,1-tris(4-hydroxyphenyl)ethane.

7. The composition according to claim 1, wherein:
the polyalkylene furanoate is polyethylene furanoate or polypropylene furanoate;
the composition comprises 0.5 to 20 parts by weight of the at least one secondary alkanesulphonate, based on 100 parts by weight of the polybutylene terephthalate and/or polyalkylene furanoate;
the at least one secondary alkanesulphonate is mixture of isomers and homologues of the general formula (I)
R¹—HC(SO₃Na)—R² (I),
in which R¹ and R² are mutually independently a C₁₆-C₁₈ alkyl moiety; and
the polycarbonate comprises a polycarbonate based on 2,2-bis(4-hydroxyphenyl)propane.

8. The composition according to claim 1, further comprising at least one elastomer modifier.

9. The composition according to claim 8, wherein the elastomer modifier comprises one or more graft polymers of at least one vinyl monomer on one or more graft bases with glass transition temperatures <10° C.

10. The composition according to claim 9, wherein:
the graft bases are acrylonitrile-butadiene-styrene polymers; and
the composition comprises 1 to 35 parts by weight of the elastomer modifier, based on 100 parts by weight of the polybutylene terephthalate and/or polyalkylene furanoate.

11. The composition according to claim 7, wherein the composition comprises:
10 to 85% by weight of the polybutylene terephthalate and/or polyalkylene furanoate;
15 to 90% by weight of the polycarbonate;
0.5 to 20 parts by weight of the at least one secondary alkanesulphonate, based on 100 parts by weight of the polybutylene terephthalate and/or polyalkylene furanoate; and
1 to 35 parts by weight of at least one elastomer modifier, based on 100 parts by weight of the polybutylene terephthalate and/or polyalkylene furanoate, wherein the elastomer modifier comprises one or more graft polymers of at least one vinyl monomer on one or more graft bases, wherein the graft bases are acrylonitrile-butadiene-styrene polymers with glass transition temperatures <10° C.

12. A process for the production of products from the composition according to claim 1, the process comprising:
mixing the components of the composition according to claim 1 to produce a moulding composition; and
forming products from the moulding composition.

13. The process according to claim 12, wherein the forming of products comprises extruding the moulding composition in the form of a strand, cooling the strand until it can be granulated, granulating the strand, and injection molding the granules to form the product.

14. The process according to claim 13, wherein the products are products in the motor vehicle industry.

15. The process according to claim 14, wherein the products are bodywork parts, wheel surrounds, bumpers, tank covers, spoilers, mirror housings, door handles, and also other panelling in the motor vehicle sector and heavy goods vehicle sector.

16. The process according to claim 12, further comprising coating the products by an electrostatic spray process (ESTA).

17. Products comprising the composition according to claim 1.

18. The products according to claim 17, wherein the products are products for the automotive industry.
